(19) United States
(12) Patent Application Publication
(10) Pub. No.: US 2009/0071239 A1
(43) Pub. Date: Mar. 19, 2009

(54) METHODS FOR OPTIMIZING PETROLEUM RESERVOIR ANALYSIS

(75) Inventors: KATHERINE ANN ROJAS, EDMONTON (CA); SHAWN DAVID TAYLOR, EDMONTON (CA); FUENGLARB ZABEL, EDMONTON (CA); OLIVER C. MULLINS, RIDGEFIELD, CT (US)

Correspondence Address: SCHLUMBERGER CANADA LIMITED, 9450 17TH AVE, EDMONTON, AB, T6N 1M9, CA

(73) Assignee: SCHLUMBERGER TECHNOLOGY CORP., SUGAR LAND, TX (US)

(21) Appl. No.: 12/204,998

(22) Filed: Sep. 5, 2008

Related U.S. Application Data
(60) Provisional application No. 60/971,989, filed on Sep. 13, 2007.

(51) Int. Cl. E21B 49/08; G01J 5/02

(52) U.S. Cl. 73/152.28; 250/343

(57) ABSTRACT

Described herein are methods for optimizing petroleum reservoir analysis and sampling using a real-time component wherein heterogeneities in fluid properties exist. The methods can help predict the recovery performance of oil such as, for example, heavy oil, which can be adversely impacted by fluid property gradients present in the reservoir.

### CROSS-REFERENCE TO RELATED APPLICATION

This application claims priority from U.S. Provisional Application 60/971,989. filed Sep. 13, 2007, which is incorporated herein by reference.

### BACKGROUND OF THE INVENTION

In petroleum reservoirs, fluid gradients may exist within an oil column. These gradients result from numerous processes such as organic sources, thermal maturity of generated oil, biodegradation, and water washing. As a result of these processes, heterogeneous fluid gradients may exist within an underground reservoir that adversely impact production rates and hydrocarbon recovery.

Current methods within the field allow for the building of geological models from data acquired during the exploration stage and for fluid models built in parallel with these geological models. Although these models serve as indicators for production rate and hydrocarbon recovery, prior to the field development stage, high uncertainty exists. This uncertainty may be reduced where the fluid column is believed to be in equilibrium through recent advances in downhole fluid analysis, sampling, and real-time fluid analysis, which have been designed for such reservoirs.

Even though advances in real-time fluid analysis for fluid columns in equilibrium are available, a need to accurately analyze fluid properties suspected to be out of equilibrium exists. Indeed, recovery performance can be adversely impacted without a clear understanding of fluid property gradients in the reservoir. Therefore, the methods described herein provide a new approach to optimize petroleum reservoir analysis using a real-time component in which heterogeneities exist within the reservoir.

### BRIEF SUMMARY OF THE INVENTION

Described herein are methods for optimizing petroleum reservoir analysis and sampling using a real-time component wherein heterogeneities in fluid properties exist. The methods can help predict the recovery performance of oil such as, for example, heavy oil, which can be adversely impacted by fluid property gradients present in the reservoir. The advantages of the invention will be set forth in part in the description which follows, and in part will be obvious from the description, or may be claims. It is to be understood that both the foregoing general description and the following detailed description are exemplary and explanatory only and are not restrictive.

### BRIEF DESCRIPTION OF THE DRAWINGS

FIG. 1 shows a schematic of the real-time component used in combination with the pre-job and post-job components as described herein for optimizing the analysis of an underground reservoir.

### DETAILED DESCRIPTION OF THE INVENTION

Before the present methods are disclosed and described, it is to be understood that the aspects described below are not limited to specific methods, as such may, of course, vary. It is also to be understood that the terminology used herein is for the purpose of describing particular aspects only and is not intended to be limiting.

In this specification and in the claims that follow, reference will be made to a number of terms that shall be defined to have the following meanings.

It must be noted that, as used in the specification and the appended claims, the singular forms “a,” “an” and “the” include plural referents unless the context clearly dictates otherwise. Thus, for example, reference to “an oil” includes the combination of two or more different oils, and the like.

“Optional” or “optionally” means that the subsequently described event or circumstance may or may not occur, and that the description includes instances where the event or circumstance occurs and instances where it does not. For example, the phrase “optionally pre-job component” means that the pre-job component may or may not be present.

The present invention will now be described with specific reference to various examples. The following examples are not intended to be limiting of the invention and are rather provided as exemplary embodiments.

Described herein are methods for optimizing petroleum reservoir analysis and sampling using a real-time component wherein heterogeneities in fluid properties exist. In general, the methods described herein are useful in analyzing downhole fluid data in real-time where one or more fluid properties of the downhole fluid are not in equilibrium. The downhole fluid as used herein is any liquid or gas present in an underground reservoir that has one or more fluid properties not in equilibrium. The phrase “not in equilibrium” is defined herein as a particular property of a downhole fluid that does not possess a constant value at particular locations and depths within the reservoir over time. For example, if the fluid property is viscosity, the viscosity of a liquid (e.g., water or oil) may vary at different locations and depths within the reservoir. Moreover, the fluid property may vary over time at the same location within the reservoir. Thus, the fluid property can vary either vertically or horizontally within the reservoir.

The term fluid property gradient is also referred to herein as gradient, or fluid gradient. The fluid property can be any phase behavior, physical property, or chemical property not in equilibrium in an underground reservoir. Examples of fluid properties that may not be in equilibrium in an underground reservoir include, but are not limited to, gas concentration, hydrocarbon content and concentration, gas/oil ratio, density, viscosity, pH, water concentration, chemical composition or distribution, phase transition pressures, condensate to gas ratios, and an abundance of biological marker compounds or biomarkers (e.g. hopanes and steranes). As an example, in such cases the fluid properties can vary due to the influence of processes aside from varying pressure and temperature, whereby the chemistry of the fluid varies spatially within the reservoir (e.g., active charging of the reservoir, active biodegradation, or varying original organic sources of the oil). In certain aspects, the distribution of any given chemical component might not be in equilibrium. For example, CO₂ might be charging into the reservoir creating a CO₂ gradient that is not in equilibrium. Alternatively, asphaltenes have a very low diffusion constant and can take excessive limes to come into equilibrium. In another example, the amount of methane present in the reservoir may be out of equilibrium. If a reservoir is currently being charged with biogenic methane, the methane concentration would likely not be in equilibrium. Other underground fluid properties include, but are not limited to, a non-equilibrium distribution of H₂S, methane to ethane ratio, isotope ratio of methane, sulfur content, or mercury content.

In one aspect, a method is provided for optimizing the analysis of a fluid property of a downhole fluid, wherein the fluid property is not in equilibrium. The method involves
(a) obtaining base data of the fluid property to produce a base model of the fluid property;
(b) acquiring real-time data of the fluid property; and
(c) fitting the real-time data in the base model to produce an optimized model of the fluid property.
   In general, step (a) is referred to as the “pre-job stage,” and steps (b) and (c) are the “real-time stage.” A “post-job stage” can be performed after step (c), which takes into account the final data set and optimized model and inputs them into a dynamic model to evaluate the impact of the fluid property. Each stage is described in detail below.

The pre-job stage generally involves creating a base model of a fluid property suspected to be in non-equilibrium. For example, the pre-job stage can include anticipating reservoir fluid property heterogeneities from sample data from comparable offset wells or by petroleum geochemical or basin knowledge of the factors controlling fluid properties, which includes petroleum geochemical interpretations. For example, geochemical analysis and interpretations may indicate a particular reservoir has or is undergoing biodegradation at the oil-water contact. In such reservoirs this typically creates a curved profile of fluid properties at the base of the column as the contact is approached, e.g. viscosity or abundance of certain biomarker compounds. Where basin knowledge or offset wells suggest that biodegradation is occurring in a new well, the gradient can be anticipated in the pre-job stage. In other aspects, the base model can be derived from equilibrium based models, a library of common fluid gradients anticipated in non-equilibrium situations, or regional basin knowledge of fluid gradients. For example, an equation of stale (EOS) base program (e.g. PVT Pro, available from Schlumberger Technology Corporation of Sugar Land, Tex., USA) can be used to predict the equilibrium based model. In one aspect, an equilibrium compositional gradient is predicted using an EOS base program. Next, certain fluid properties (e.g. viscosity and density) can be calculated based on the predicted compositional gradient and formula used for calculating these properties in a reservoir simulator. In this aspect, the EOS base program can be used for generating and analyzing pressure-volume-temperature (PVT) data based on measurements performed on petroleum mixtures.

In certain aspects, when no prior knowledge of the fluid properly is available, a range of typical fluid properties can be used as base cases, such as, for example, linear, parabolic, or logarithmic type gradients. The fluid property data is used as an input to produce a reservoir model (i.e., base model), whereby the reservoir model can be either a static or basic dynamic reservoir model. From the reservoir model, the impact of the anticipated heterogeneity in fluid property on production and recovery is evaluated, which is described below. Sensitivities on this anticipated gradient can also indicate the value of obtaining additional sample points, hence optimizing the sampling job in particular in the real-time stage.

The following is an exemplary pre-job stage. Real-time fluid property measurements, such as downhole fluid analysis (DFA) station data and/or lab measurements from downhole fluid samples versus depth, and/or data from offset wells or similar regional sands, are gathered and incorporated into a reservoir model (e.g., static or basic dynamic model). Software can curve fit data points to determine gradients in fluid properties with depth (e.g., composition versus depth) for input into a reservoir model. In one aspect, data analysis software, such as, for example, Microsoft Excel, can be used to curve fit data points and obtain a fluid property profile. As described above, if such data is not available, a library of known gradients can be run for sensitivity analysis or used as base cases, or one can be selected based on geochemistry or basin knowledge (i.e., linear gradient, parabolic, logarithmic).

After the equilibrium model (i.e., base model) has been generated, the next step (the real-time stage) involves acquiring real-time data of the fluid property suspected of not being in equilibrium. If the real-time data do not follow the same trend as the predicted trend, it indicates that the real-time fluid property data may belong to a different compartment or the system may not be in equilibrium. Geochemistry can then be employed further analyze what causes the deviation in the fluid property from the base model (e.g., the predicted equilibrium fluid properly gradient). After evaluating the possible geochemistry processes that may occur in the reservoir, different possible fluid property gradients can be identified and further evaluated. For example, fluid property gradients such as linear, parabolic, and logarithmic may be identified.

Sampling (i.e., acquisition of real-time data) can be accomplished using downhole tools known in the art. For example, one approach to downhole fluid sampling involves the use of a wireline formation testing and sampling tool (WFT). The use of a WFT results in the acquisition of continuous real-time data over time. The contents of the flowline in the WFT can be analyzed by any DFA mode such as, for example, visible-near-infrared absorption spectroscopy. Not wishing to be bound by theory, the light absorption properties of crude oils differ from those of gas, water, and oil-based mud filtrate. These techniques permit the quantitative analysis of the fluids flowing through a downhole fluid analyzer, which is useful in comparing the real-time data to predicted values as described below. In one aspect, the samples can be analyzed on-site at the surface to evaluate the fluid property of interest. For example, PVTExpress service, offered by Schlumberger Technology Corporation, can be used to evaluate the fluid property. In other aspects, samples can be analyzed at a separate location in a laboratory environment to obtain fluid property data. Analysis of the data then leads to a subsequent sampling job where additional samples of real-time data are acquired at defined specific sampling stations. In other aspects, a variety of downhole fluid analysis tools can be employed during wireline logging. For example, the LFA tool, available from Schlumberger Technology Corporation, measures gas-oil ratio and color, which can be related to asphaltenc content. The CFA tool, available from Schlumberger Technology Corporation, measures methane content, and other hydrocarbon gases and liquids. The LFA-pH tool, also available from Schlumberger Technology Corporation, measures the pH of water samples. Other downhole fluid analysis measurements can be made such as density and viscosity. All of these measurements can also be made during the drilling stage of a well in the measurements while drilling mode. In another aspect, the real-time data can be acquired by a sample from a drilling tool, a production logging tool string, or a cased-hole bottomhole sampler.

During the acquisition of the real-time data, the anticipated fluid properties in the base model are fitted (i.e., replaced) with actual data as sample data is acquired (step (b), including geochemical data where on-site analysis is possible). In real-time, the sampling job can be optimized using the available equipment so reservoir fluid information of maximum value can be obtained. As the fluid property is determined and additional data is acquired, the base model can be optimized sample by sample to select the best sampling location to test the anticipated gradient. A sufficient amount of real-time data is obtained so that the most probable gradient curve of the fluid property of interest is developed. In situations where a newly acquired data point does not fit the expected trend, the knowledge outlined above will be used to re-design the sampling program to best select the location of the next sample to test the newly anticipated trend, hence optimizing the model of the fluid property. Alternatively, sampling may be increased during the job if the exact locations of sharp contrasts in fluid properties occur. After a sufficient amount of real-time data has been acquired, a profile of the fluid property of interest is produced, which can be used to accurately predict variations of the fluid property at particular points within the reservoir. By understanding the fluid properties not in equilibrium in the reservoir, it is possible to optimize the equipment at the job site.

In one aspect, once the real-time measurement data at new locations are obtained, they can be input into the EOS base model to determine the new pseudo-component composition data at these depths. The composition data versus depth can then be updated and plotted using software, such as, for example, Microsoft Excel, to include these new data points. The new compositional profile can then be used to compare how well it aligns with the base model. In addition, other fluid property profiles (e.g. viscosity and density) can be calculated based on the new composition data and formula used for calculating these properties in a reservoir simulator. Similarly, these other fluid property profiles can be plotted and compared with the base model. As described below, the updated fluid property data versus depth will be input into a reservoir simulator to predict the production performance. The amount of real-time data collected from the reservoir is sufficient to produce an optimized model of the fluid properly. The degree of optimization can vary depending upon the desired level of optimization and the standard error of the measuring tool.

In one aspect, the real-time stage involves quantifying the fluid properly at a specific depth in an underground reservoir. In this aspect, the sampling and analysis are completed in real-time using downhole fluid analysis tools capable of providing fluid property data while the tool remains at the station. In this aspect, it is also possible to compare in real-time the newly acquired data with the measurements acquired at different depths in the same well, with other samples in other wellbores in the same field, or with samples from other relevant nearby fields.

After a sufficient amount of real-time data has been acquired and fitted with the base model to produce an optimized model, a detailed static or dynamic reservoir model can be produced which takes into account one or more fluid properties not in equilibrium. This is referred to herein as the “post-job stage” described above. In one aspect, the post-job stage involves building a detailed static and/or detailed dynamic reservoir model where fluid property variations (e.g., viscosity, density) at a particular depth in the reservoir can be represented. The post-job stage also is useful in predicting the impact the fluid property(ies) has on the production performance (e.g., number of barrels/day), which will be described in more detail below.

In certain aspects, it may not be possible to extract samples from the underground reservoir using conventional sampling methods and, thus, obtain real-time data. An example of this is heavy oil. The term “heavy oil” is any source or form of viscous oil. For example, a source of heavy oil includes tar sand. Tar sand, also referred to as oil sand or bituminous sand, is a combination of clay, sand, water, and bitumen. Most heavy oil cannot be extracted using conventional sampling methods. The methods for obtaining real-time data on heavy oil are discussed below. In one aspect, described herein is a method for predicting heavy oil recovery performance from an underground reservoir at a particular depth, the method comprising:
(a) producing a base model of a fluid properly at a particular depth:
(b) correlating the fluid property in the base model to heavy oil recovery performance at the particular depth to produce a theoretical recovery performance model;
(c) acquiring real-time data of the fluid properly at a particular depth: and
(d) comparing the real-time data of the fluid property at a particular depth to the theoretical recovery performance model to predict heavy oil recovery performance at a particular depth in the underground reservoir.

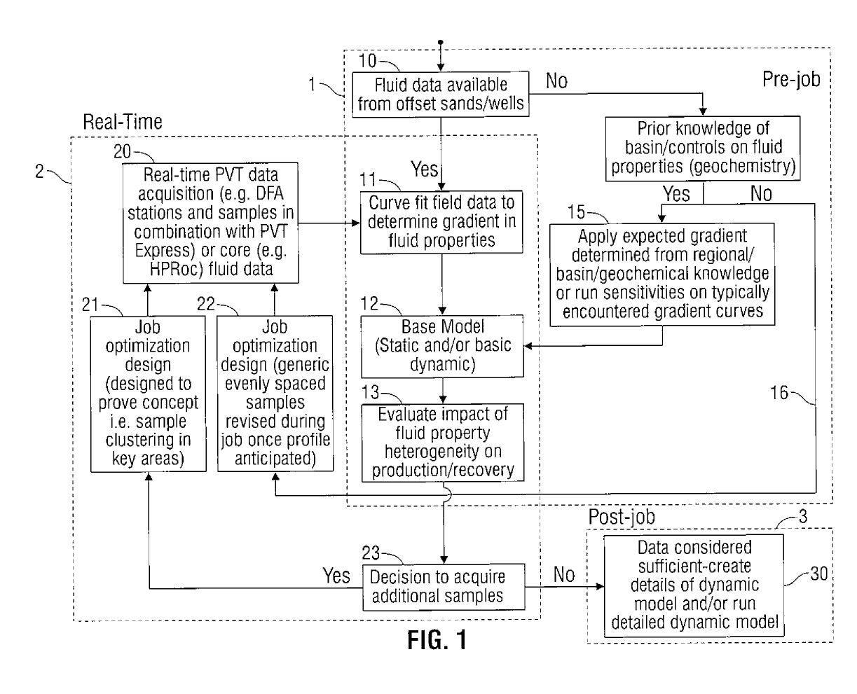

FIG. 1 shows a flow diagram for evaluating heavy oil recovery performance using the methods described herein. In general, the method helps evaluate the impact a fluid property or gradient has on production and recovery of heavy oil and other related underground fluids.

The first step involves obtaining or creating a base model of the fluid property at a particular depth. Fluid property gradients of interest with respect to heavy oils include, but are not limited to, parabolic shaped profiles rates of biodegradation, filling or charging rates, and diffusive mixing. It is desirable to keep the reservoir model simple enough so that the CPU time usage for each simulation run is relatively short and within the realistic run time on the rig. Therefore, the number of grid blocks should not be too large and the fluid property should be characterized to a limited number of pseudo-components. In one aspect, a minimum of two liquid pseudo-components, or three liquid pseudo-components can be used to prepare the base model of one or more fluid properties of the heavy oil. Examples of such pseudo-components include, but are not limited to, solution gas, light liquid component, heavy liquid component, or any combination thereof. “Solution gas” refers to the lightest pseudo-component composed of hydrocarbons with lighter molecular weight than “light liquid component” (e.g. C1 to C6). This pseudo-component can also include other non-hydrocarbon gaseous components, e.g. CO₂ or H₂S. “Light liquid component” refers to an intermediate pseudo-component composed of hydrocarbons with higher molecular weight than “solution gas” but lower molecular weight than “heavy liquid component” (e.g. C7 to C29). “Heavy liquid component” refers to the heaviest pseudo-component composed of the hydrocarbons with higher molecular weight than those in “light liquid component” (e.g. C30 to C80).

In one aspect, the base model is based upon fluid data derived from samples obtained from adjacent wells in the field. This is depicted in FIG. 1 as 10, which is the first step of Pre-job stage 1. Although the process depicted in FIG. 1 is applied to heavy oil as described below, it can be applied to the evaluation of any fluid property described herein. For example, reservoir properties may be known from other sources of data such as, for example, well logging. The data can be curve fitted (11) using software known in the art to produce a base model (12 in FIG. 1). For example, fluid property data obtained from previous samplings at a particular depth can be used for tuning an equation of state (EOS) model. The tuned EOS model can then be used to predict the fluid properties at different depths. Once additional fluid property data is obtained by real-time time sampling as discussed below, the real-time data can be used to compare with those predicted from the EOS model.

In other aspects, if no prior fluid sampling data is available from the field of interest, a simple generic static model can still be built based on reservoir and fluid characterizations from a similar type of reservoir. This is depicted as 15 in FIG. 1. This data can subsequently be used to produce the base model (12). In this aspect, no fluid property has been evaluated before in the field of interest. Many factors can be considered when generating the base model. For example, source rock type, heating rate, and mixing in the reservoir are relevant parameters. Additionally, the fluid can be altered by a second charge or by biodegradation. Finally, the reservoir itself can be tilted or modified in temperature or pressure, which creates new conditions in which the fluids react.

The next step involves correlating the fluid property in the base model to heavy oil recovery performance at the particular depth to produce a theoretical recovery performance model. This is depicted as 13 in FIG. 1. Computer software can be used to evaluate the effects of different fluid property gradients on production performance. In one aspect, ECLIPSE computer software, available from Schlumberger Technology Corporation, can be used to evaluate the impact the fluid property has on the recovery performance. The use of ECLIPSE software is described in more detail below. Variables of interest related to production performance include hydrocarbon production rates, cumulative hydrocarbon production, and hydrocarbon recovery. In this step, the relative impact of different fluid property gradients on the production results is examined and not the actual values of production. For example, if the impact from different fluid property gradients is small, resulting in an ultimate recovery difference within 20% among the proposed fluid property gradients, it is not necessary to collect additional samples. However, if the impact from the different fluid properly gradients is more significant, the sampling program can be designed to optimize the minimum sampling locations necessary to obtain the best representative fluid properly gradient. This is depicted as 23 in FIG. 1. The sampling program may need to be refined at more depths depending on how strongly the production performances are affected from different fluid properly gradients. For example, if the fluid property has a significant impact on ultimate recovery (e.g., a two fold difference in recovery), sampling from another location, for example at one third from the bottom depth, could be performed.

After a satisfactory theoretical recovery performance model has been produced, real-time data is acquired at particular depths and compared to the theoretical recovery performance model to predict heavy oil recovery performance at a particular depth in the underground reservoir. This is the Real-Time stage 2 depicted in FIG. 1. The real-time data can be acquired at different locations or spacing. For example, real-time data can be acquired in a clustered manner at a particular area to verify a fluid property of interest (21 in FIG. 1). Alternatively, real-time data can be acquired at evenly spaced locations throughout the field to obtain a general profile of the fluid properly within the field (22 in FIG. I). In this aspect, this is useful when there is no prior knowledge of the field of interest (depicted as line 16 in FIG. 1) and base data is required to produce a base model.

Real-time data can be acquired using techniques known in the art. For example, real-time PVT data acquisition can be accomplished by the analysis of DFA samples by PVTExpress software, offered by Schlumberger Technology Corporation. In other aspects, core fluid data can be obtained by a core sampling tool, such as HPRoc, also offered by Schlumberger Technology Corporation. The acquisition of real-time data is depicted as 20 in FIG. 1. Sampling can be accomplished using the techniques described above (e.g., WFT). Once the real-time data is obtained from the proposed sampling location, it is then compared to the theoretical recovery performance model. In one aspect, ECLIPSE reservoir simulator software uses different fluid properly data to predict production performance for the oil recovery process of interest. Additional real-time data is acquired to ultimately forecast heavy oil production based upon one or more fluid properties of interest. If additional data needs to be acquired (23), further sampling can be performed.

After a sufficient amount of real-time data has been obtained to predict the impact of production performance based upon one or more fluid properties, the Post-job stage (3 in FIG. 1) involves building a more complex geological model 30 using the real-time fluid property data obtained above coupled with the best representative fluid property data obtained from Pre-job stage 1. For example, production performance can be mapped out at different depths and locations within the reservoir in view of one or more fluids. Ultimately, the model provides a useful tool in predicting recovery performance of the heavy oil at different depths and locations throughout the reservoir where it is suspected that one or more fluid properties are not in equilibrium. A variety of different sources of data are used to produce the geological model, which includes data acquired during the exploration stage (e.g., seismic surfaces, well tops, formation evaluation logs, and pressure measurements). Other considerations include wireline petrophysics, fluid data, pressure data, production data, mud gas isotope analysis, and geochemistry.

Various modifications and variations can be made to the methods described herein. Other aspects of the methods described herein will be apparent from consideration of the specification and practice of the methods disclosed herein. It is intended that the specification and examples be considered as exemplary.

What is claimed is:

1. A method of optimizing the analysis of a fluid property of a downhole fluid in an underground reservoir, wherein the fluid property is not in equilibrium, the method comprising:
(a) obtaining base data of the fluid properly to produce a base model of the fluid property;
(b) acquiring real-time data of the fluid property; and
(c) fitting the real-time data in the base model to produce an optimized model of the fluid property.

2. The method of claim 1, wherein the fluid properly comprises gas concentration, hydrocarbon content and concentration, gas/oil ratio, density, viscosity, biodegradation, pH, water concentration, chemical concentrations and distributions, phase transition pressures, the presence or absence of a biomarker, or condensate to gas ratios.

3. The method of claim 1, wherein the base data comprises anticipated data of the fluid property derived from an equilibrium based model, a library of fluid properties that are known to be in non-equilibrium, or regional basin knowledge of the fluid property.

4. The method of claim 1, wherein the real-time data is derived from a wireline formation testing and sampling tool sample, a sample from a drilling tool, a production logging tool string, or a cased-hole bottomhole sampler.

5. The method of claim 1, wherein the real-time data is acquired by a downhole fluid analysis (DFA) mode.

6. The method of claim 5, wherein the downhole fluid analysis (DFA) mode comprises visible-near-infrared absorption spectroscopy.

7. The method of claim 1, wherein the acquiring of real-time data comprises quantifying the fluid property at a specific depth in the underground reservoir.

8. The method of claim 1, wherein after step (c), producing a detailed static or dynamic reservoir model comprising fluid property variations relative to depth in the underground reservoir.

9. The method of claim 1, wherein the real-time data is acquired on-site at the reservoir.

10. The method of claim 1, wherein the real-time data is acquired in a laboratory.

11. The method of claim 1, wherein the downhole fluid comprises a non-equilibrium distribution of asphaltene, methane, CO₂, H₂S, methane to ethane ratio, isotope ratio of methane, sulfur content, or mercury content.

12. A method for predicting heavy oil recovery performance from an underground reservoir at a particular depth, the method comprising:
(a) producing a base model of a fluid properly at a particular depth;
(b) correlating the fluid property in the base model to heavy oil recovery performance at the particular depth to produce a theoretical recovery performance model;
(c) acquiring real-time data of the fluid property at a particular depth: and
(d) comparing the real-time data of the fluid property at a particular depth to the theoretical recovery performance model to predict heavy oil recovery performance at a particular depth in the underground reservoir.

13. The method of claim 12, wherein the base model is derived from samples at different depths within the same well.

14. The method of claim 12, wherein the base model is derived from samples obtained from wellbores in the same field.

15. The method of claim 12, wherein the base model is derived from data of at least two fluid properties in the reservoir.

16. The method of claim 12, wherein the base model is derived from data of at least three fluid properties in the reservoir.

17. The method of claim 12, wherein the base model is derived from a similar underground reservoir.

18. The method of claim 12, wherein the fluid property comprises the rate of biodegradation, the filling or charging rate, the rate of diffusive mixing, gas concentration, hydrocarbon content and concentration, gas/oil ratio, density, viscosity, biodegradation, pH, water concentration, chemical concentrations and distributions, phase transition pressures, or condensate to gas ratios.

19. The method of claim 12, wherein the base model comprises an equation of state (EOS) model of the fluid properly.

20. The method of claim 12, wherein in step (b) hydrocarbon production rate, cumulative hydrocarbon production, and hydrocarbon recovery are correlated to the fluid property at a particular depth.

21. The method of claim 12, wherein the real-time data is derived from a wireline formation testing and sampling tool sample, a sample from a drilling tool, a production logging tool string, or a cased-hole bottomhole sampler.

22. The method of claim 12, wherein the real-time data is acquired by a downhole fluid analysis (DFA) mode.

23. The method of claim 22, wherein the downhole fluid analysis (DFA) mode comprises visible-near-infrared absorption spectroscopy.

24. The method of claim 12, wherein after step (d), creating a geological model of the underground reservoir based upon the real-time data of the fluid property obtained at different depths within the same well, wherein the real-time data is obtained from multiple wells.
